(19) United States
(12) Patent Application Publication
(10) Pub. No.: US 2025/0153131 A1
(43) Pub. Date: May 15, 2025

(54) FLUIDIZED BED REACTOR SYSTEM CAPABLE OF REGENERATING FLUIDIZED PARTICLES AND OPERATING METHOD THEREOF

(71) Applicant: KOREA INSTITUTE OF ENERGY RESEARCH, Daejeon (KR)

(72) Inventors: Ho-Jung RYU, Daejeon (KR); Sun-Mi HWANG, Sejong-si (KR); Byung Wook HWANG, Daejeon (KR); Soon-kwan JEONG, Sejong-si (KR); Sun A CHOI, Daejeon (KR); Daewook KIM, Daejeon (KR); Yooseob WON, Daejeon (KR); Seung-yong LEE, Daejeon (KR); Sung-ho JO, Daejeon (KR); Yu Jin CHOI, Daejeon (KR)

(73) Assignee: KOREA INSTITUTE OF ENERGY RESEARCH, Daejeon (KR)

(21) Appl. No.: 18/941,102

(22) Filed: Nov. 8, 2024

(30) Foreign Application Priority Data
Nov. 9, 2023 (KR) 10-2023-0154053

(51) Int. Cl. B01J 8/26

(52) U.S. Cl. CPC B01J 8/26; B01J 2208/00539; B01J 2208/00548; B01J 2208/00663; B01J 2208/00991

(57) ABSTRACT

The present disclosure relates to a fluidized bed reactor system capable of regenerating fluidized particles and operating method thereof, more particularly to a fluidized bed reactor system capable of regenerating fluidized particles including: a fluidized reactor into which a fluidizing gas is injected; a regeneration fluidized bed reactor with a gas inlet and a gas outlet; a solid moving path that is connected between the fluidized bed reactor and the regeneration fluidized bed reactor to transfer solid particles; a first control valve that is installed on one side of the solid moving path; and a second control valve that is installed on the gas outlet of the regeneration fluidized bed reactor.

### CROSS-REFERENCE TO RELATED APPLICATIONS

This application claims priority to and the benefit of Korea Patent Application No. 10-2023-0154053 filed in the Korean Intellectual Property Office on Nov. 9, 2023, the contents of which are incorporated herein by reference in their entirety.

### BACKGROUND

### Technical Field

The present disclosure relates to a fluidized bed reactor system capable of regenerating fluidized particles and operating method thereof.

### Related Art

FIG. 1 shows a schematic view of a typical fluidized bed. A gas-solid fluidized bed reactor 10, as shown in FIG. 1, is a device that changes the behavior of solid particle(s) (fluidized particle(s)) similar to that of a fluid. This is achieved by charging solid particles into the fluidized bed and then injecting gas through a plenum 12 and a gas distributor 13 at the bottom of the reactor to suspend the solid particles. This fluidized bed reactor 10 includes a fluidizing gas inlet 11 and an outlet 14.

When solid particles in a fixed bed (or packed bed) condition are fluidized, they are changed to a bubbling fluidized bed condition (although there are cases when fluidization occurs without forming bubbles). The solid particles existing in dense-phase inside the fluidized bed reactor 10 exhibit behavior very similar to that of liquid and the contact efficiency between the solid and gas is much higher compared to other contact methods.

When the fluid velocity is increased beyond that of the bubbling fluidized bed, the bubble size increases rapidly and finally the bubble diameter becomes equal to the column diameter, a phenomenon known as slugging. A continuous increase in fluid velocity, in the case of slugging, fragments slugs into smaller bubbles, or, in the case of the bubbling fluidized bed, increases bubble frequency, enhancing bed uniformity. The boundary of the bubble shape becomes blurred gradually, the boundary between bubble and emulsion phases indistinct. This condition is known as turbulent bed.

The solid concentration in the turbulent bed is decreased, while it is maintained in the fluidized bed. As fluid velocity increases more in the turbulent bed, the attrition of solid particles and the elutriation of particles increase rapidly. When the fluid velocity exceeds the particle transfer velocity, all particles in the bed are elutriated, requiring recirculation by a cyclone. This condition is known as fast fluidized bed.

Fluidized bed processes are widely used, due to their superior solid mixing, mass transfer and heat transfer characteristics compared to other reactors, in 1) physical operations such as drying, adsorption, cooling, freezing, coating, solid conveying, temperature control, filtration, and thermostatic control, 2) chemical reactions employed in catalytic reactors such as fluid catalytic cracking (FCC), oxychlorination, phthalic anhydride production, and polymer polymerization, 3) non-catalytic reactions such as coal combustion, coal gasification, calcination, mineral roasting, and waste incineration, and 4) energy conversion processes.

When only one reaction such as combustion, pyrolysis, gasification, absorption, oxidation, reduction and adsorption occurs in the fluidized bed, operation with one fluidized bed is possible. When continuous operation requires two different reactions to occur simultaneously, such as oxidation-reduction and absorption-regeneration, two different fluidized beds are used and multiple-bed circulating fluidized bed processes where solids are circulated between the two reactors are occasionally used.

There are cases where the performance of fluidized particles participating in a reaction deteriorates during the operation using a fluidized bed.

For example, when a raw material containing carbon or hydrocarbons is introduced as a reactant to produce a new substance, as reaction conditions change or reaction time passes, a coking phenomenon, which is the deposition of carbon on the fluidized particle (carbon deposition), may occur. Carbon deposits on the surface of the fluidized particle, causing a rapid decrease in reactivity. In this case, new fluidized particles are added (made-up) or the whole or part of the fluidized particles is discharged to the outside and the carbon deposited by oxygen, air and steam can be combusted and then returned to fluidized bed.

For another example, the performance of fluidized particles with reducing (or oxidizing) properties deteriorates over time or changes in reaction conditions as the initial reducing (or oxidizing) property decrease. In this case, new fluidized particles are added (made-up) or to regenerate particles with reducing (or oxidizing) properties, the whole or part of the fluidized particles is discharged to the outside and a reduction reaction (or oxidation reaction) is carried out by injecting reducing gas such as hydrogen and carbon oxide (or oxidizing gas such as oxygen, air and steam), regenerating the particles to their initial reducing (or oxidizing) properties.

In such cases where the performance of fluidized particles changes, a process of new fluidized particle make-up or regenerating the fluidized particles to their original reactivity is required to maintain product quality.

FIG. 2 shows an exemplary schematic view of a gas-solid fluidized bed capable of making-up and discharging fluidized particles. As shown in FIG. 2, compared to the fluidized bed shown in FIG. 1, this fluidized bed requires additional installations of a fresh particle silo (storage, raw material silo) 20, solid feeding device 30, solid removal device 40, and spent particle silo (storage) 50.

When a change in the composition or amount of the product gas in the fluidized bed is detected, indicating the need of making-up of new fluidized particles, fresh particles charged into the fresh particle silo (storage, raw material silo) 20 are fed into the fluidized bed through the solid feeding device 30. When new fluidized particles are fed into the fluidized bed, the amount of solids in the fluidized bed increases due to the feeding of particles. Therefore, to maintain a constant height of the solid bed inside the fluidized bed reactor 10, particles inside the fluidized bed reactor 10 must be discharged in proportion to the feeding amount of particles.

To achieve this, the solid removal device 40 is operated to control the height of the solid bed inside the fluidized bed reactor 10 at a constant level. The discharged fluidized particles are stored in the spent particle silo (storage) 50. Additionally, the discharged fluidized particles are subjected to a regeneration process in another reactor and then charged into the fresh particle silo (storage, raw material silo) 20 for potential reuse.

In such cases where the fluidized particles are made-up, as compared to the typical gas-solid fluidized bed process shown in FIG. 1, this fluidized bed requires additional installations of the fresh particle silo (storage, raw material silo) 20, solid feeding device 30, solid removal device 40, and spent particle silo (storage) 50. Moreover, another reactor is needed for the regeneration of spent particles. Additionally, when the reaction occurring in the fluidized bed is at a high temperature, the temperature inside the fluidized bed may decrease due to the made-up particles.

FIG. 3 shows an exemplary case where fluidized particles are continuously regenerated and recirculated. As shown in FIG. 3, the fluidized particles discharged from the lower part of the fluidized bed reactor 10 are introduced into a regeneration fluidized bed reactor 80 via a first loop seal (loop seal 1) 60.

A loop seal 1 fluidizing gas is injected to the lower part of the first loop seal (loop seal 1) 60 (through a loop seal 1 fluidizing gas inlet 61) to transfer solid particles and to prevent gas mixing between fluidized bed-regeneration fluidized bed. The fluidized particles introduced into the regeneration fluidized bed reactor 80 are fluidized by a regeneration fluidizing gas (through a regeneration fluidizing gas inlet) and, after undergoing a regeneration reaction, move upward and are introduced into a cyclone 1. As mentioned above, the regeneration fluidizing gas can be oxygen, air, steam, hydrogen, and carbon oxide, depending on the type of regeneration reaction. The generation fluidized particles introduced into the cyclone 1 are captured in the cyclone 1 and discharged to the lower part of the cyclone 1 solid outlet 3 and then introduced into a second loop seal (loop seal 2) 70. The regeneration gas is discharged through a gas removal device 2 at the upper part of the cyclone 1.

A loop seal 2 fluidizing gas is injected to the lower part of the second loop seal (loop seal 2) (through a loop seal 2 fluidizing gas inlet 71) to transfer solid particles and to prevent gas mixing between regeneration fluidized bed-fluidized bed. The fluidized particles via the second loop seal (loop seal 2) 70 are recirculated to the fluidized bed reactor 10.

As shown in FIG. 3, in the case where fluidized particles are continuously regenerated and recirculated, as compared to the typical gas-solid fluidized bed process shown in FIG. 1, this fluidized bed requires additional installations of the first loop seal (loop seal 1) 60, second loop seal (loop seal 2) 70, regeneration fluidized bed reactor 80, and cyclone 1. Furthermore, additional fluidizing gases are needed to maintain the fluidized state of the first loop seal (loop seal 1) 60 and second loop seal (loop seal 2) 70.

Typically, inert gases such as nitrogen and argon, or steam that can be condensed downstream and removed to avoid affecting the composition of the product, are primarily used as fluidizing gases for the first loop seal (loop seal 1) 60 and the second loop seal (loop seal 2) 70.

On the other hand, in the case of the regeneration fluidized bed reactor 80, a high-speed gas is injected to transfer solid particles upward, and a fast fluidized bed is primarily used. However, when a reaction rate of the regeneration reaction (such as combustion of deposited carbon, reduction reaction, and oxidation reaction) is slow, sufficient regeneration reaction may not occur due to the short gas-solid contact time inside the fast fluidized bed. In this case, the regeneration reaction should be carried out under turbulent fluidized bed or bubbling fluidized bed conditions, and in some cases, a fast fluidized bed may be additionally needed to recirculate the regenerated fluidized particles.

In the case where fluidized particles are continuously regenerated and recirculated, as compared to the typical gas-solid fluidized bed process shown in FIG. 1, this fluidized bed requires additional installations of the first loop seal (loop seal 1) 60, second loop seal (loop seal 2) 70, regeneration fluidized bed reactor 80, and cyclone 1. Furthermore, when the reaction occurring in the fluidized bed is at a high temperature, the temperature inside the fluidized bed may decrease due to the temperature of fluidized particles recirculated. Thus, preheating the particles in the second loop seal (loop seal 2) 70 is needed before injection.

### RELATED ART DOCUMENT

### Patent Document

(Patent Document 1) U.S. Pat. No. 8,277,736 B2
(Patent Document 2) Korean Patent No. 10-1984542
(Patent Document 3) Korean Patent No. 10-1120433
(Patent Document 4) Korean Patent No. 10-1573297

### DETAILED DESCRIPTION

### Technical Problem

Therefore, the present disclosure is contrived to address conventional issues as described above. According to an embodiment of the present disclosure, it aims to provide a fluidized bed system capable of regenerating fluidized particles and operating method thereof, wherein a regeneration reaction may be selectively performed only when regeneration of the fluidized particles is required.

According to an embodiment of the present disclosure, it aims to provide a fluidized bed system capable of regenerating fluidized particles and operating method thereof, wherein additional installations may be minimized compared to cases where fluidized particles are made-up or continuously regenerated and recirculated.

According to an embodiment of the present disclosure, it aims to provide a fluidized bed system capable of regenerating fluidized particles and operating method thereof, which may easily maintain the temperature of the fluidized bed due to less cooling of the fluidized particles compared to cases where fluidized particles are made-up or continuously regenerated and recirculated.

According to an embodiment of the present disclosure, it aims to provide a fluidized bed system capable of regenerating fluidized particles and operating method thereof, which requires a smaller amount of additional gas consumption compared to the case where fluidized particles are continuously regenerated and recirculated.

Meanwhile, technical objects to be achieved in the present invention are not limited to the aforementioned technical objects, and other technical objects, which are not mentioned above, will be apparently understood to a person having ordinary skill in the art from the following description.

### Technical Solution

According to a first aspect of the present disclosure, it can be achieved by a fluidized bed reactor system capable of regenerating fluidized particles, including: a fluidized bed reactor system capable of regenerating fluidized particles including: a fluidized reactor into which a fluidizing gas is injected; a regeneration fluidized bed reactor with a gas inlet and a gas outlet; a solid moving path that is connected between the fluidized bed reactor and the regeneration fluidized bed reactor to transfer solid particles; and a first control valve that is installed on one side of the solid moving path.

Further, the fluidized bed reactor system capable of regenerating fluidized particles may be characterized in that the gas inlet is configured to inject a regeneration fluidizing gas or inert gas into the lower part of the regeneration fluidized bed reactor, and gas outlet is configured to discharge a regeneration gas or inert gas to the upper part of the regeneration fluidized bed reactor.

Yet further, the fluidized bed reactor system capable of regenerating fluidized particles may be characterized by including a second control valve that is installed on the gas outlet of the regeneration fluidized bed reactor

Yet further, the fluidized bed reactor system capable of regenerating fluidized particles may be characterized by including a first measuring system that measures a pressure or differential pressure within the fluidized bed reactor.

Yet further, the fluidized bed reactor system capable of regenerating fluidized particles may be characterized by including a second measuring system that measures a pressure or differential pressure within the regeneration fluidized bed reactor.

Yet further, the fluidized bed reactor system capable of regenerating fluidized particles may be characterized by further including a controller that controls the first control valve and the second control valve based on values measured by the first measuring system and the second measuring system.

Yet further, the fluidized bed reactor system capable of regenerating fluidized particles may be characterized in that a cross-sectional area of the regeneration fluidized bed reactor is smaller than a cross-sectional area of the fluidized bed reactor.

A second aspect of the present disclosure may be achieved by an operating method of a fluidized bed reactor system capable of regenerating fluidized particles according to the aforementioned first aspect, including: a first step of closing a first control valve, opening a second control valve, and injecting a fluidizing gas into a fluidized bed reactor; a second step of injecting an inert gas into a regeneration fluidized bed reactor, when required regeneration; a third step of opening the first control valve to allow fluidized particles to move from the fluidized bed reactor to the regeneration fluidized bed reactor through a solid moving path; a fourth step of closing the first control valve; a fifth step of exchanging the inert gas with a regeneration fluidizing gas to carry out a regeneration reaction in the regeneration fluidized bed reactor; a sixth step of exchanging the regeneration fluidizing gas with an inert gas; a seventh step of opening the first control valve, closing the second control valve, increasing an internal pressure of the regeneration fluidized bed reactor to be higher than an internal pressure of the fluidized bed reactor, and moving solid particles to the fluidized bed reactor; and an eighth step of closing the first control valve and opening the second control valve.

Further, the operating method of a fluidized bed reactor system capable of regenerating fluidized particles may be characterized by including a ninth step of opening the second control valve and stopping gas injection into the regeneration fluidized bed reactor.

Yet further, the operating method of a fluidized bed reactor system capable of regenerating fluidized particles may be characterized in that, in the third step, when a pressure P1 of the fluidized bed reactor and a pressure P2 of the regeneration fluidized bed reactor are the same, the particles are moved until a height H1 of a solid bed within the fluidized bed reactor and a height H2 of a solid bed within the regeneration fluidized bed reactor become the same.

Yet further, the operating method of a fluidized bed reactor system capable of regenerating fluidized particles may be characterized in that, in the fourth step, the first control valve is closed to prevent particle movement between the fluidized bed reactor and the regeneration fluidized bed reactor, and a product gas in the fluidized bed reactor is purged, wherein the completion of the purging is detected by analyzing a concentration and flow rate of a gas discharged from the regeneration fluidized bed reactor.

Yet further, the operating method of a fluidized bed reactor system capable of regenerating fluidized particles may be characterized in that, in the fifth step, the completion of the regeneration reaction is detected by analyzing a concentration and flow rate of a gas discharged from the regeneration fluidized bed reactor, and, in the sixth step, the regeneration fluidizing gas is exchanged with an inert gas in the regeneration fluidized bed reactor to purge the regeneration fluidized bed reactor, wherein the completion of the purging is detected by analyzing a concentration and flow rate of a gas discharged from the regeneration fluidized bed reactor.

### Advantageous Effects

According to a fluidized bed system capable of regenerating fluidized particles and operating method thereof in accordance of the embodiment of the present disclosure, there is an effect of being able to selectively perform a regeneration reaction only when regeneration of the fluidized particles is required.

According to a fluidized bed system capable of regenerating fluidized particles and operating method thereof in accordance of the embodiment of the present disclosure, there is an advantage of minimizing additional installations compared to cases where fluidized particles are made-up or continuously regenerated and recirculated.

According to a fluidized bed system capable of regenerating fluidized particles and operating method thereof in accordance of the embodiment of the present disclosure, there is an advantage of easily maintaining the temperature of the fluidized bed due to less cooling of the fluidized particles compared to cases where fluidized particles are made-up or continuously regenerated and recirculated.

According to a fluidized bed system capable of regenerating fluidized particles and operating method thereof in accordance of the embodiment of the present disclosure, there is an advantage of requires a smaller amount of additional gas consumption compared to the case where fluidized particles are continuously regenerated and recirculated.

Meanwhile, advantageous effects to be obtained in the present disclosure are not limited to the aforementioned effects, and other effects, which are not mentioned above, will be apparently understood to a person having ordinary skill in the art from the following description.

### BRIEF DESCRIPTION OF THE DRAWINGS

The accompanying drawings of this specification exemplify a preferred embodiment of the present disclosure, the spirit of the present disclosure will be more clearly understood from the following detailed description taken in conjunction with the accompanying drawings, and thus it will be understood that the present disclosure is not limited to only contents illustrated in the accompanying drawings;

FIG. 1 is a schematic view of a typical gas-solid fluidized bed,

FIG. 2 is a schematic view of a gas-solid fluidized bed capable of making-up and discharging fluidized particles,

FIG. 3 is an exemplary case where fluidized particles are continuously regenerated and recirculated.

FIG. 4 is a schematic view of a gas-solid fluidized bed reactor system capable of regenerating fluidized particles according to an embodiment of the present disclosure,

FIG. 5 is a block diagram showing the signal flow of a controller according to an embodiment of the present disclosure,

FIG. 6 is a flowchart of an operating method of a fluidized bed reactor system capable of regenerating fluidized particles according to an embodiment of the present disclosure,

FIG. 7 is a table showing the operation method for each operating step according to an embodiment of the present disclosure,

FIG. 8 is a schematic view of a gas-solid fluidized bed reactor system capable of regenerating fluidized particles according to an embodiment of the present disclosure in the first step.

FIG. 9 is a schematic view of a gas-solid fluidized bed reactor system capable of regenerating fluidized particles according to an embodiment of the present disclosure in the third step.

FIG. 10 is a schematic view of a gas-solid fluidized bed reactor system capable of regenerating fluidized particles according to an embodiment of the present disclosure in the seventh step.

FIG. 11 is a schematic view of a gas-solid fluidized bed reactor system capable of regenerating fluidized particles according to an embodiment of the present disclosure in the eighth step, and

FIG. 12 is a schematic view of a gas-solid fluidized bed reactor system capable of regenerating fluidized particles according to an embodiment of the present disclosure in the ninth step.

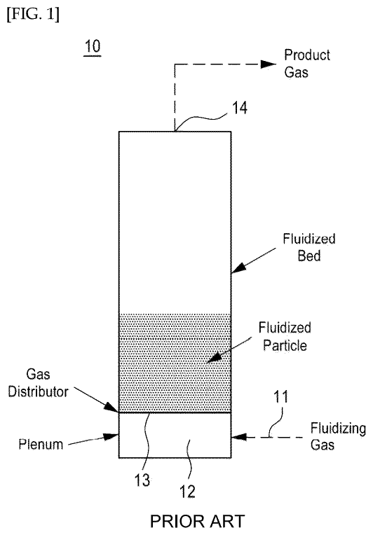

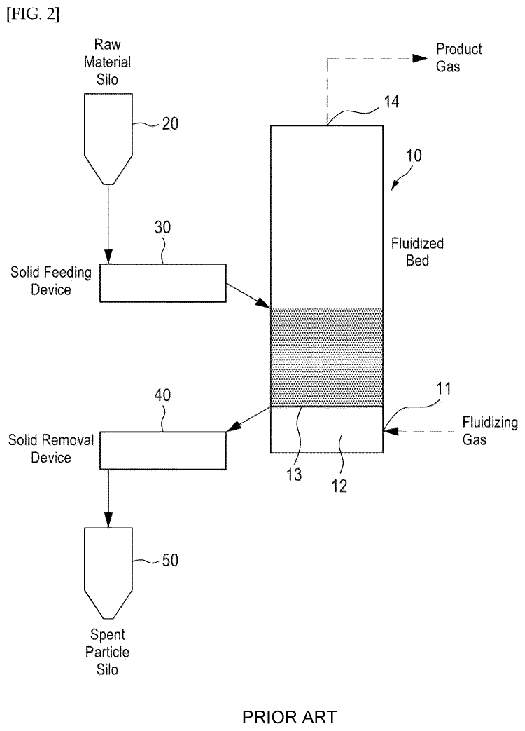

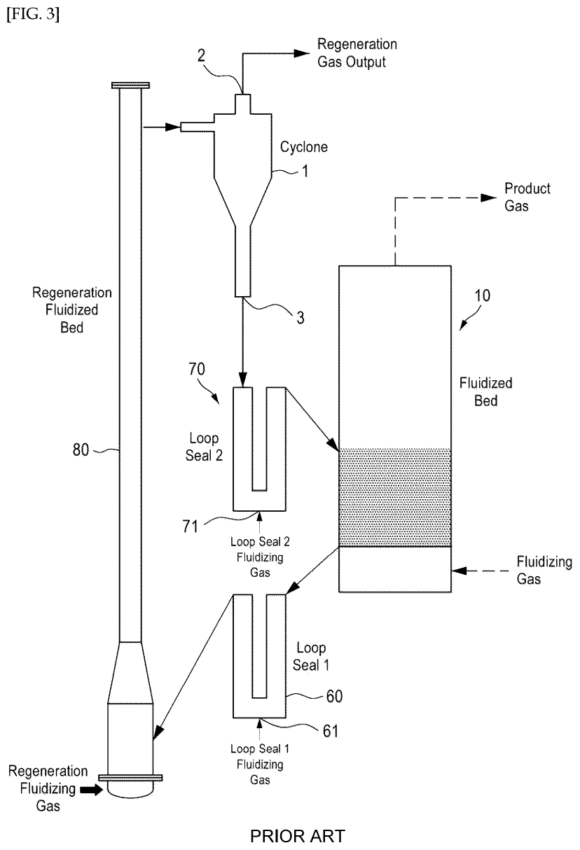

### DETAILED DESCRIPTION

Hereinafter, the aforementioned aims, other aims, features and advantageous effects of the present disclosure will be understood easily referring to preferable embodiments related to the accompanying drawings. However, the present disclosure is not limited to embodiments described in this specification, and may be embodied into other forms. Preferably, the embodiments in this specification are provided in order to allow disclosed contents to be exhaustive and to communicate the concept of the present disclosure to those skilled in the art.

In this specification, when a certain element is placed on another element, this means that it may be formed directly thereon or that the third element may be interposed between them. Further, in the drawings, the thickness of an element may be overstated in order to explain the technical content thereof efficiently.

The embodiments described in this specification will explained with reference to a cross-sectional view and/or a plane view. In the drawings, the thickness of a film and a region may be overstated in order to explain the technical content thereof efficiently. Accordingly, the form of exemplary drawings for a fabrication method and/or an allowable error et cetera may be reformed. Thus, the embodiments according to the present disclosure are not limited to specific forms illustrated herein, but may include variations in the form resulting from the fabrication method. For example, the region illustrated with perpendicular lines may have a form to be rounded or with a predetermined curvature. Thus, regions exemplified in the drawings have attributes, and shapes thereof exemplify specific forms rather than limiting the scope of the present disclosure. In the various embodiments of this specification, terms such as ‘first’ and ‘second’ et cetera are used to describe various elements, but these elements should not be limited to such terms. These terms are merely used to distinguish one element from others. The embodiments explained and exemplified herein may include complementary embodiments thereto.

The terms used in this specification is to explain the embodiments rather than limiting the present disclosure. In this specification, the singular expression includes the plural expression unless specifically stated otherwise. The terms, such as ‘comprise” and/or “comprising” do not preclude the potential existences of one or more elements.

When describing the following specific embodiments, various kinds of specific contents are made up to explain the present disclosure in detail and to help understanding thereof. However, it will be apparent for those who have knowledge to the extent of understanding the present disclosure that the present disclosure can be used without any of these specific contents. In a certain case when describing the present disclosure, the content that is commonly known to the public but is largely irrelevant to the present disclosure is not described in order to avoid confusion.

Hereinafter, the configuration of a fluidized bed reactor system capable of regenerating fluidized particles, according to an embodiment of the present disclosure, is described.

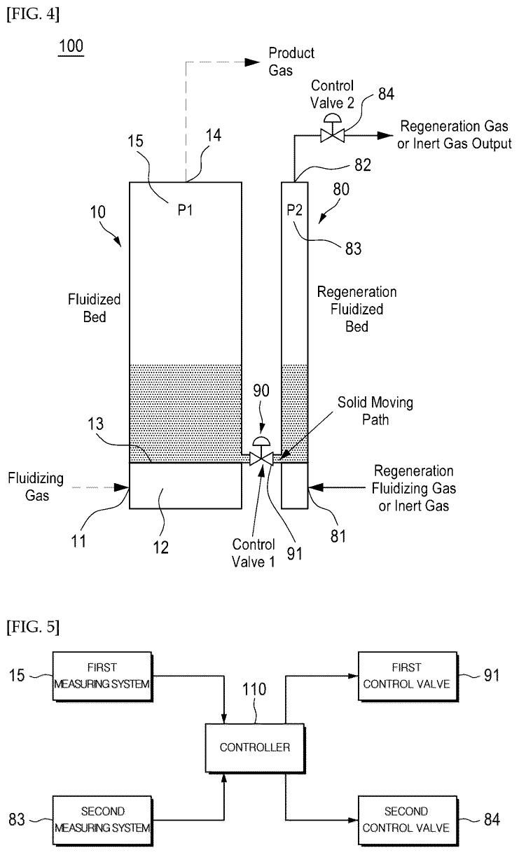

Firstly, FIG. 4 is a schematic view of a gas-solid fluidized bed reactor system capable of regenerating fluidized particles according to an embodiment of the present disclosure. FIG. 5 is a block diagram showing the signal flow of a controller according to an embodiment of the present disclosure.

A fluidized bed reactor 10 is injected with a fluidizing gas through a fluidizing gas inlet and includes a plenum and a gas distributor.

A first measuring system 15 is configured to measure an internal pressure of the fluidized bed reactor 10.

A regeneration fluidized bed reactor 80 includes a gas inlet 81 and a gas outlet 82.

The gas inlet 81 is configured to inject a regeneration fluidizing gas or inert gas into the lower part of the regeneration fluidized bed reactor 80.

The gas outlet is configured to discharge a regeneration gas or inert gas to the upper part of the regeneration fluidized bed reactor 80.

In an embodiment of the present disclosure, a solid moving path 90 is included which is connected between the fluidized bed reactor 10 and the regeneration fluidized bed reactor 80 and transfers solid particles (fluidized particles).

A first control valve 91 is installed on one side of the solid moving path 90.

In addition, in an embodiment of the present disclosure, a second control valve 84 is installed on the gas outlet 82 of the regeneration fluidized bed reactor 80.

The aforementioned first measuring system 15 is configured to measure a pressure or differential pressure within the fluidized bed reactor 10.

A second measuring system 83 is configured to measure a pressure or differential pressure within the regeneration fluidized bed reactor 80.

A controller 110 controls the first control valve 91 and the second control valve 84 based on values measured by the first measuring system 15 and the second measuring system 83.

Hereinafter, operating and control methods of a fluidized bed system 100 capable of regenerating fluidized particles, according to an embodiment of the present disclosure, are described in detail.

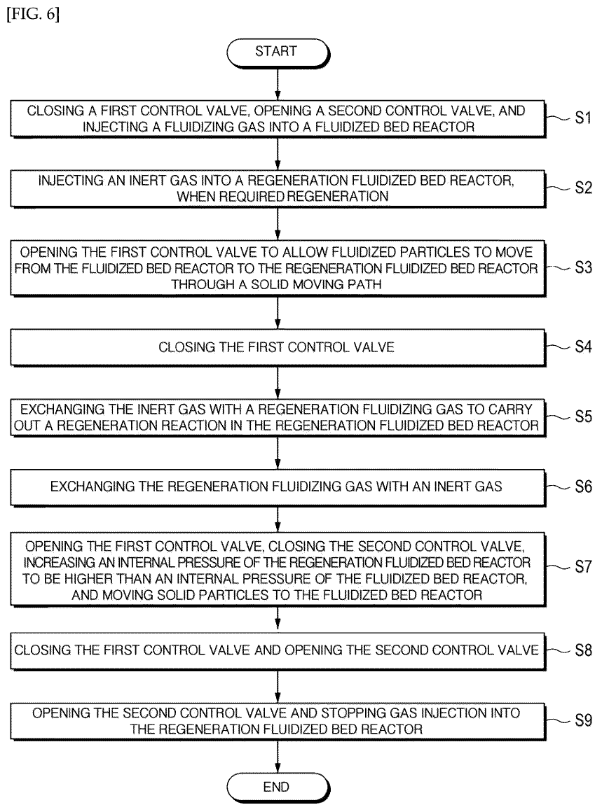

FIG. 6 is a flowchart of an operating method of a fluidized bed reactor system capable of regenerating fluidized particles according to an embodiment of the present disclosure.

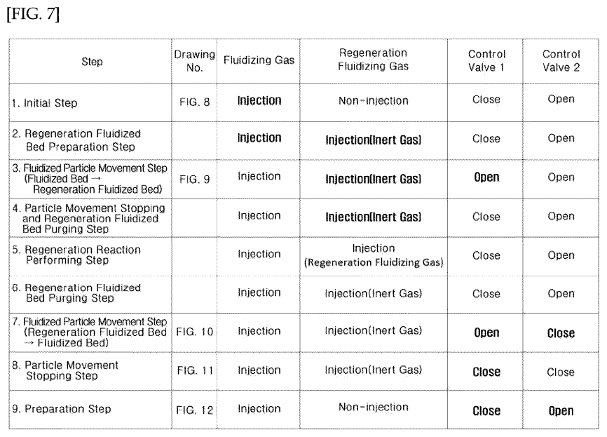

FIG. 7 is a table showing the operation method for each operating step according to an embodiment of the present disclosure.

In an embodiment of the present disclosure, when a change in the composition or amount of the product gas in the fluidized bed is detected, indicating the need of regeneration of fluidized particles, the following steps are performed to regenerate the fluidized particles.

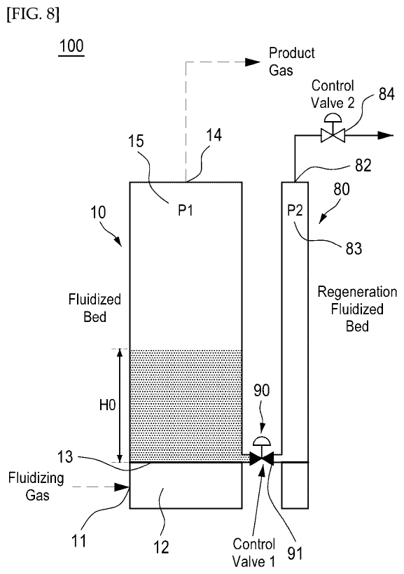

FIG. 8 is a schematic view of a gas-solid fluidized bed reactor system capable of regenerating fluidized particles according to an embodiment of the present disclosure in the first step.

At the beginning of operation, the first step S1, as shown in FIG. 5, a fluidizing gas in injected into only the fluidized bed reactor 10, and the first control valve 91 is closed. There are no fluidized particles inside the regeneration fluidized bed reactor 80, and the second control valve 84 is open.

In the second step S2, an inert gas injected into the regeneration fluidized bed reactor 80 while the first control valve is closed and the second control valve 84 is open.

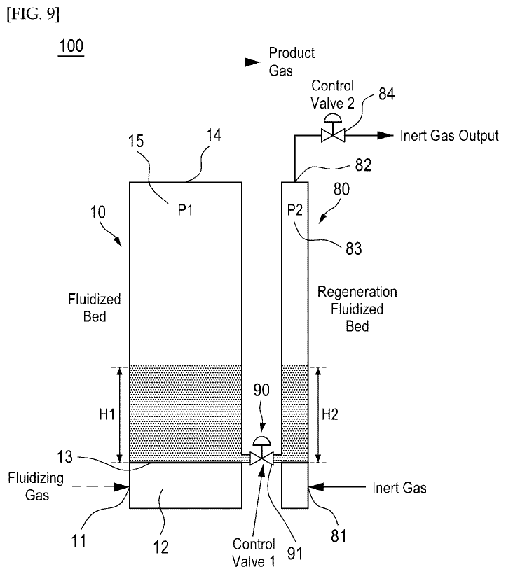

FIG. 9 is a schematic view of a gas-solid fluidized bed reactor system capable of regenerating fluidized particles according to an embodiment of the present disclosure in the third step.

In the third step S3, the first control valve 91 is opened to transfer fluidized particles from the fluidized bed reactor 10 to the regeneration fluidized bed reactor 80 through the solid moving path 90 (fluidized particle movement: fluidized bed→regeneration fluidized bed).

Since the fluidizing gas and regeneration fluidizing gas are being injected into the fluidized bed reactor 10 and the regeneration fluidized bed reactor 80, the fluidized particles within the fluidized bed reactor 10 are fluidized, exhibiting fluid and fluid-like behaviors. Since the first control valve 91 between the fluidized bed reactor 10 and the regeneration fluidized bed reactor 80 is open, particles can move through the solid moving path 90 between the two fluidized beds, similar to a U-shaped tube.

When a pressure P1 of the fluidized bed reactor 10 and a pressure P2 of the regeneration fluidized bed reactor 80 are the same, as shown in FIG. 9, the particles are moved until a height H1 of a solid bed within the fluidized bed reactor and a height H2 of a solid bed within the regeneration fluidized bed reactor become the same.

Meanwhile, as the fluidized particles have moved from the fluidized bed reactor 10 to the regeneration fluidized bed reactor 80, the height H1 of the solid bed within the fluidized bed reactor as shown in FIG. 9 becomes lower compared to a height H0 of the fluidized bed reactor 10 in the first step as shown in FIG. 8. The completion of particle transfer from the fluidized bed reactor 10 to the regeneration fluidized bed reactor 80 can be recognized by measuring differential pressures across the solid beds within both the fluidized bed reactor 10 and the regeneration fluidized bed reactor 80 (not illustrated in the present disclosure). The completion of the fluidized particle transfer can be determined when a differential pressure ΔP1 of the solid bed in the fluidized bed reactor 10 decreases slightly and becomes equal to a differential pressure ΔP2 of the solid bed in the regeneration fluidized bed reactor 80, and no further changes occur.

On the other hand, when P1 and P2 are not the same, the height of the solid bed inside the fluidized bed reactor 1) and the height of the solid bed inside the regeneration fluidized bed reactor 80 are maintained while the difference between ΔP1 and ΔP2 is equal to the difference between P1 and P2 (differential pressure ΔP).

In the fourth step S4, the first control valve 91 is closed to prevent particle movement between the fluidized bed reactor 10 and the regeneration fluidized bed reactor 80 (step of stopping particle movement and purging regeneration fluid bed).

Even during this step, the fluidizing gas and regeneration fluidizing gas are being injected into the regeneration fluidized bed reactor 80. Therefore, reaction gases (fluidized bed reactor fluidizing gas and product gas generated by the reaction occurring in the fluidized bed reactor) that may be entrained with the particles can be purged. The completion of the purging is detected by analyzing a concentration and flow rate of a gas discharged from the regeneration fluidized bed reactor 80 (not illustrated in the present disclosure).

In the fifth step S5, the regeneration fluidizing gas is exchanged from an inert gas to a regeneration fluidizing gas to carry out a regeneration reaction (step of performing regeneration reaction). The completion of the regeneration reaction is detected by analyzing a concentration and flow rate of a gas discharged from the regeneration fluidized bed reactor 80 (not illustrated in the present disclosure).

In the sixth step S6, the regeneration fluidizing gas is exchanged from a regeneration fluidizing gas to an inert gas (step of purging regeneration fluidized bed). The completion of the purging is detected by analyzing a concentration and flow rate of a gas discharged from the regeneration fluidized bed reactor 80 (not illustrated in the present disclosure).

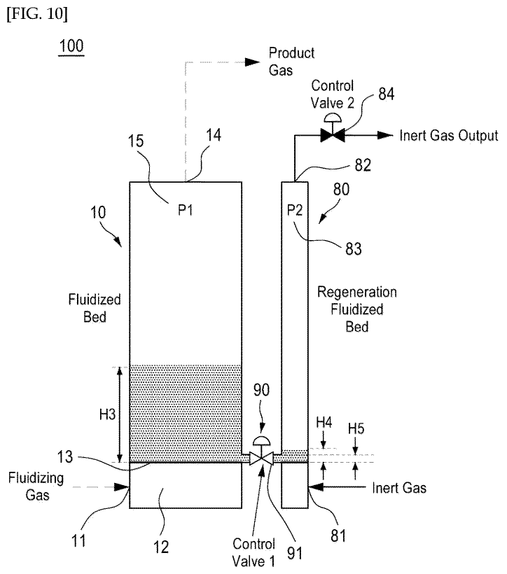

FIG. 10 is a schematic view of a gas-solid fluidized bed reactor system capable of regenerating fluidized particles according to an embodiment of the present disclosure in the seventh step.

In the seventh step S7, after opening the first control valve 91, the second control valve 84 is closed to increase the internal pressure P2 of the regeneration fluidized bed reactor 80 relative to the internal pressure P1 of the fluidized bed reactor 10. As P2 increases relative to P1, as shown in FIG. 10, the particles inside the fluidized bed reactor 10 and the regeneration fluidized bed reactor 80 behave similarly to the fluid in the U-shaped tube, and a height H4 of the solid bed decreases as much as the differential pressure (ΔP=P2−P1) between P1 and P2. As a height H3 of the solid inside the fluidized bed reactor 10 increases, the regenerated fluidized particles move from the regeneration fluidized bed reactor 82 to the fluidized bed reactor 10 through the solid moving path 10.

At this time, the height H3 inside the fluidized bed reactor 10 is lower than the height H0 in the first step shown in FIG. 8, and higher than the height of the solid bed in the state where the fluidized particles move from the fluidized bed reactor 10 to the regeneration fluidized bed reactor 80 as shown in FIG. 9 (H0>H3>H1).

Meanwhile, when P2 increases excessively compared to P1, the height H4 of the solid bed inside the regeneration fluidized bed reactor 80 decreases further, and in severe cases, there may be no particles in the solid moving path 90. Therefore, solids are moved until the height H4 of the solid inside the regeneration fluidized bed reactor 80 is maintained higher than a height H5 of the solid moving path 90. To achieve this, when H4 approaches H5, the height may be controlled by reducing the flow rate of the inert gas supplied to the regeneration fluidized bed reactor 80.

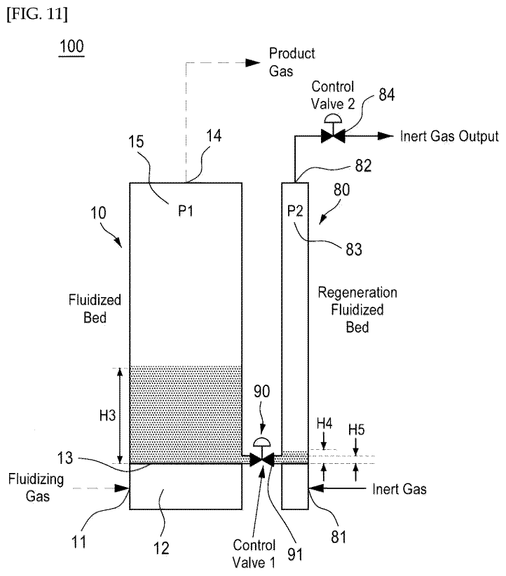

FIG. 11 is a schematic view of a gas-solid fluidized bed reactor system capable of regenerating fluidized particles according to an embodiment of the present disclosure in the eighth step. In the eighth step S8, as shown in FIG. 11, the first control valve 91 is closed to stop the movement of the fluidized particles (step of stopping particle movement).

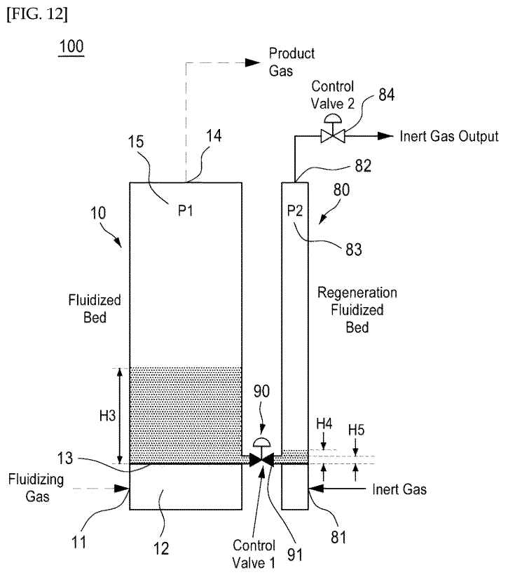

FIG. 12 is a schematic view of a gas-solid fluidized bed reactor system capable of regenerating fluidized particles according to an embodiment of the present disclosure in the ninth step.

In the ninth step S9, after stopping the injection of regeneration fluidizing gas, the second control valve 84 is opened to prepare for the next step. As shown in FIG. 12, the preparation step is identical to the first step as shown in FIG. 8 in terms of Open/Close states of the valves and injection states of the fluidizing gas and regeneration fluidizing gas. However, a portion of the fluidized particles remains in the regeneration fluidized bed reactor 80 (H4≠0, H4>H5). As a result, the height H3 of the solid bed inside the fluidized bed reactor 10 during the ninth step is maintained lower than the height H0 of the solid bed inside the fluidized bed reactor 10 in the first step (H0>H3).

Meanwhile, in order to minimize abrupt change in the height of the solid bed inside the fluidized bed reactor 10 due to the movement of fluidized particles between the fluidized bed reactor 10 and the generation fluidized bed reactor 80, and to minimize the consumption of inert gas and regeneration fluidizing gas, it is advantageous to make the cross-section area of the regeneration fluidized bed reactor 80 smaller than the cross-sectional area of the fluidized bed reactor 10 (i.e., the cross-sectional area of the regeneration fluidized bed is selected to be smaller than the cross-sectional area of the fluidized bed).

Further, the configuration and method of the embodiments as described above are not restrictively applied to the aforementioned apparatus and method. The whole or part of the respective embodiments may be selectively combined so as to make various modifications of the embodiments.

### FIGURE REFERENCE NUMBERS

1: cyclone
2: cyclone gas outlet
3: cyclone solid outlet
10: fluidized bed reactor
11: fluidizing gas inlet
12: plenum
13: gas distributor
14: outlet
15: first measuring system
20: fresh particle silo (storage)
30: solid feeding device
40: solid removal device
50: spent particle silo (storage)
60: first loop seal (loop seal 1)
61: loop seal 1 fluidizing gas inlet
70: second loop seal (loop seal 2)
71: loop seal 2 fluidizing gas inlet
80: regeneration fluidized bed reactor
81: gas inlet
82: gas outlet
83: second measuring system
84: second control valve
90: solid moving path
91: first control valve
100: fluidized bed system capable of regenerating fluidized particles
110: controller

1. A fluidized bed reactor system capable of regenerating fluidized particles comprising:
a fluidized reactor into which a fluidizing gas is injected;
a regeneration fluidized bed reactor with a gas inlet and a gas outlet;
a solid moving path that is connected between the fluidized bed reactor and the regeneration fluidized bed reactor to transfer solid particles;
a first control valve that is installed on one side of the solid moving path; and
a second control valve that is installed on the gas outlet of the regeneration fluidized bed reactor.

2. The fluidized bed reactor system capable of regenerating fluidized particles of claim 1, wherein
the gas inlet is configured to inject a regeneration fluidizing gas or inert gas into the lower part of the regeneration fluidized bed reactor, and
the gas outlet is configured to discharge a regeneration gas or inert gas to the upper part of the regeneration fluidized bed reactor.

3. The fluidized bed reactor system capable of regenerating fluidized particles of claim 2, comprising:
a first measuring system that measures a pressure or differential pressure within the fluidized bed reactor.

4. The fluidized bed reactor system capable of regenerating fluidized particles of claim 3, comprising:
a second measuring system that measures a pressure or differential pressure within the regeneration fluidized bed reactor.

5. The fluidized bed reactor system capable of regenerating fluidized particles of claim 4, further comprising:
a controller that controls the first control valve and the second control valve based on values measured by the first measuring system and the second measuring system.

6. The fluidized bed reactor system capable of regenerating fluidized particles of claim 1, wherein
a cross-sectional area of the regeneration fluidized bed reactor is smaller than a cross-sectional area of the fluidized bed reactor.

7. An operating method of a fluidized bed reactor system capable of regenerating fluidized particles according to claim 1, comprising:
a first step of closing a first control valve, opening a second control valve, and injecting a fluidizing gas into a fluidized bed reactor;
a second step of injecting an inert gas into a regeneration fluidized bed reactor, when required;
a third step of opening the first control valve to allow fluidized particles to move from the fluidized bed reactor to the regeneration fluidized bed reactor through a solid moving path;
a fourth step of closing the first control valve;
a fifth step of exchanging the inert gas with a regeneration fluidizing gas to carry out a regeneration reaction in the regeneration fluidized bed reactor;
a sixth step of exchanging the regeneration fluidizing gas with an inert gas;
a seventh step of opening the first control valve, closing the second control valve, increasing an internal pressure of the regeneration fluidized bed reactor to be higher than an internal pressure of the fluidized bed reactor, and moving solid particles to the fluidized bed reactor; and
an eighth step of closing the first control valve and opening the second control valve.

8. The operating method of a fluidized bed reactor system capable of regenerating fluidized particles of claim 7, comprising:
a ninth step of opening the second control valve and stopping gas injection into the regeneration fluidized bed reactor.

9. The operating method of a fluidized bed reactor system capable of regenerating fluidized particles of claim 8, wherein
in the third step,
when a pressure P1 of the fluidized bed reactor and a pressure P2
of the regeneration fluidized bed reactor are the same, the particles are moved until a height H1 of a solid bed within the fluidized bed reactor and a height H2 of a solid bed within the regeneration fluidized bed reactor become the same.

10. The operating method of a fluidized bed reactor system capable of regenerating fluidized particles of claim 9, wherein
in the fourth step,
the first control valve is closed to prevent particle movement between the fluidized bed reactor and the regeneration fluidized bed reactor, and
a product gas in the fluidized bed reactor is purged, wherein the completion of the purging is detected by analyzing a concentration and flow rate of a gas discharged from the regeneration fluidized bed reactor.

11. The operating method of a fluidized bed reactor system capable of regenerating fluidized particles of claim 10, wherein
in the fifth step, the completion of the regeneration reaction is detected by analyzing a concentration and flow rate of a gas discharged from the regeneration fluidized bed reactor, and
in the sixth step, the regeneration fluidizing gas is exchanged with an inert gas in the regeneration fluidized bed reactor to purge the regeneration fluidized bed reactor, wherein the completion of the purging is detected by analyzing a concentration and flow rate of a gas discharged from the regeneration fluidized bed reactor.

12. The operating method of a fluidized bed reactor system capable of regenerating fluidized particles of claim 11, wherein
in the seventh step, solids are moved until a height H4 of the solid bed within the fluidized bed reactor and a height H5 of the solid bed within the regeneration fluidized bed reactor become the same, wherein to achieve this, as H4 approaches H5, a flow rate of the inert gas supplied to the regeneration fluidized bed reactor is reduced to control the height.

13. An operating method of a fluidized bed reactor system capable of regenerating fluidized particles according to claim 2, comprising:
a first step of closing a first control valve, opening a second control valve, and injecting a fluidizing gas into a fluidized bed reactor;
a second step of injecting an inert gas into a regeneration fluidized bed reactor, when required;
a third step of opening the first control valve to allow fluidized particles to move from the fluidized bed reactor to the regeneration fluidized bed reactor through a solid moving path;
a fourth step of closing the first control valve;
a fifth step of exchanging the inert gas with a regeneration fluidizing gas to carry out a regeneration reaction in the regeneration fluidized bed reactor;
a sixth step of exchanging the regeneration fluidizing gas with an inert gas;
a seventh step of opening the first control valve, closing the second control valve, increasing an internal pressure of the regeneration fluidized bed reactor to be higher than an internal pressure of the fluidized bed reactor, and moving solid particles to the fluidized bed reactor; and
an eighth step of closing the first control valve and opening the second control valve.

14. An operating method of a fluidized bed reactor system capable of regenerating fluidized particles according to claim 3, comprising:
a first step of closing a first control valve, opening a second control valve, and injecting a fluidizing gas into a fluidized bed reactor;
a second step of injecting an inert gas into a regeneration fluidized bed reactor, when required;
a third step of opening the first control valve to allow fluidized particles to move from the fluidized bed reactor to the regeneration fluidized bed reactor through a solid moving path;
a fourth step of closing the first control valve;
a fifth step of exchanging the inert gas with a regeneration fluidizing gas to carry out a regeneration reaction in the regeneration fluidized bed reactor;
a sixth step of exchanging the regeneration fluidizing gas with an inert gas;
a seventh step of opening the first control valve, closing the second control valve, increasing an internal pressure of the regeneration fluidized bed reactor to be higher than an internal pressure of the fluidized bed reactor, and moving solid particles to the fluidized bed reactor; and
an eighth step of closing the first control valve and opening the second control valve.

15. An operating method of a fluidized bed reactor system capable of regenerating fluidized particles according to claim 4, comprising:
a first step of closing a first control valve, opening a second control valve, and injecting a fluidizing gas into a fluidized bed reactor;
a second step of injecting an inert gas into a regeneration fluidized bed reactor, when required;
a third step of opening the first control valve to allow fluidized particles to move from the fluidized bed reactor to the regeneration fluidized bed reactor through a solid moving path;
a fourth step of closing the first control valve;
a fifth step of exchanging the inert gas with a regeneration fluidizing gas to carry out a regeneration reaction in the regeneration fluidized bed reactor;
a sixth step of exchanging the regeneration fluidizing gas with an inert gas;
a seventh step of opening the first control valve, closing the second control valve, increasing an internal pressure of the regeneration fluidized bed reactor to be higher than an internal pressure of the fluidized bed reactor, and moving solid particles to the fluidized bed reactor; and
an eighth step of closing the first control valve and opening the second control valve.

16. An operating method of a fluidized bed reactor system capable of regenerating fluidized particles according to claim 5, comprising:
a first step of closing a first control valve, opening a second control valve, and injecting a fluidizing gas into a fluidized bed reactor;
a second step of injecting an inert gas into a regeneration fluidized bed reactor, when required;
a third step of opening the first control valve to allow fluidized particles to move from the fluidized bed reactor to the regeneration fluidized bed reactor through a solid moving path;
a fourth step of closing the first control valve;
a fifth step of exchanging the inert gas with a regeneration fluidizing gas to carry out a regeneration reaction in the regeneration fluidized bed reactor;
a sixth step of exchanging the regeneration fluidizing gas with an inert gas;
a seventh step of opening the first control valve, closing the second control valve, increasing an internal pressure of the regeneration fluidized bed reactor to be higher than an internal pressure of the fluidized bed reactor, and moving solid particles to the fluidized bed reactor; and
an eighth step of closing the first control valve and opening the second control valve.

17. An operating method of a fluidized bed reactor system capable of regenerating fluidized particles according to claim 6, comprising:
a first step of closing a first control valve, opening a second control valve, and injecting a fluidizing gas into a fluidized bed reactor;
a second step of injecting an inert gas into a regeneration fluidized bed reactor, when required;
a third step of opening the first control valve to allow fluidized particles to move from the fluidized bed reactor to the regeneration fluidized bed reactor through a solid moving path;
a fourth step of closing the first control valve;
a fifth step of exchanging the inert gas with a regeneration fluidizing gas to carry out a regeneration reaction in the regeneration fluidized bed reactor;
a sixth step of exchanging the regeneration fluidizing gas with an inert gas;
a seventh step of opening the first control valve, closing the second control valve, increasing an internal pressure of the regeneration fluidized bed reactor to be higher than an internal pressure of the fluidized bed reactor, and moving solid particles to the fluidized bed reactor; and
an eighth step of closing the first control valve and opening the second control valve.
